(19) United States
(12) Patent Application Publication
(10) Pub. No.: US 2016/0152825 A1
(43) Pub. Date: Jun. 2, 2016

(54) PROCESS FOR PRODUCING COMPOSITES

(71) Applicants: Rainer LOMOELDER, Muenster (DE); Dirk Hoppe, Nottuln (DE); Christoph Nacke, Schermbeck (DE); Sebastian De Nardo, Gelsenkirchen (DE)

(72) Inventors: Rainer LOMOELDER, Muenster (DE); Dirk Hoppe, Nottuln (DE); Christoph Nacke, Schermbeck (DE); Sebastian De Nardo, Gelsenkirchen (DE)

(73) Assignee: Evonik Degussa GmbH, Essen (DE)

(21) Appl. No.: 14/953,073

(22) Filed: Nov. 27, 2015

(30) Foreign Application Priority Data
Nov. 28, 2014 (EP) EP14195385

(51) Int. Cl. C08L 75/04; C08K 7/06; C08K 7/14

(52) U.S. Cl. CPC C08L 75/04; C08K 7/14; C08K 7/06

(57) ABSTRACT

A composite is produced by I. producing a reactive composition containing A) at least one organic diisocyanate and/or polyisocyanate; B) at least one compound having at least one functional group reactive toward NCO groups, wherein the ratio of NCO groups of A) and the functional groups of B) varies from 1:2 to 2:1; C) a catalyst mixture containing C1) at least one titanium compound and C2) at least one bismuth compound in a C1:C2 ratio of 100:1 to 1:100; and D) optionally, an additive; wherein the amounts of A)-D) add up to 100% by weight, II. directly impregnating a fibrous carrier with the composition from I., to obtain an impregnated fibrous carrier, III. shaping the impregnated fibrous carrier to give a molding, and IV. curing the reactive composition I.

### BACKGROUND OF THE INVENTION

1. Field of the Invention

The invention provides a process for producing composites.

2. Discussion of the Background

Polyurethanes having long been known and have already been produced in tailored form for different requirements (U.S. Pat. No. 5,952,053). In order to control the polymerization rate, a large number of different metal catalysts have already been examined and used. In addition to the commonly used organotin compounds, these also include organo compounds or organic salts of various other elements, for example mercury, titanium and bismuth.

In the past, organic mercury catalysts in particular have been used with preference for many applications. However, it is known that mercury compounds are toxic, and so there has already been a search in the past for alternative catalyst systems. For instance, WO 2005/058996 describes a catalyst mixture of titanium compounds and bismuth compounds having a similar profile of reactivity to mercury compounds. Catalyst mixtures of this kind have been tested for polyurethane elastomers. Similar catalyst combinations are also mentioned in patent U.S. Pat. No. 5,902,835. This describes a method for producing polyurethane foams, in which catalyst mixtures of titanium compounds, zirconium compounds or hafnium compounds are used in combination with bismuth compounds or amines. Patent EP 1432749 describes a process for producing polyurethane elastomers containing amine catalysts and catalyst mixtures of lithium compounds, titanium compounds and/or zirconium compounds and optionally bismuth compounds. Typical fields of use of the polyurethane elastomers described are foams, domed labels, shoe soles, adhesives and sealants. However, no catalyst combinations of this kind are described for composite applications, i.e. applications in which fibre-reinforced plastics are used.

The last few years have seen development of polyurethane systems which are reinforced with fibre material and find use in automobile construction or the wind energy sector because of their high toughness. The demands on polyurethanes for such applications are very high. It is especially important that the matrix exhibits very good binding to the fibre material.

### SUMMARY OF THE INVENTION

The problem addressed by the present invention was therefore that of finding a method for production of fibre-reinforced composites which, after curing, exhibit particularly good attachment to the fibre.

The present invention relates to a process for producing a composite, comprising:

I. producing a reactive composition comprising
A) at least one organic diisocyanate and/or polyisocyanate;
B) at least one compound having at least one functional group reactive toward NCO groups,

wherein the ratio of NCO groups of A) and the functional groups of B) varies from 1:2 to 2:1;
C) a catalyst mixture comprising
   C1) at least one titanium compound and
   C2) at least one bismuth compound in a C1:C2 ratio of 100:1 to 1:100; and
D) optionally, an additive;

wherein the amounts of A)-D) add up to 100% by weight,

II. directly impregnating a fibrous carrier with the composition from I., to obtain an impregnated fibrous carrier,

III. shaping the impregnated fibrous carrier to give a molding, and

IV. curing the reactive composition I.

In addition, the present invention relates to the composite obtained by the above process.

### DETAILED DESCRIPTION OF THE INVENTION

Any ranges mentioned herein below include all values and subvalues between the lowest and highest limits of that range.

It has been found that, surprisingly, the process according to the invention, after curing, exhibits particularly good binding to the fibre and is therefore especially suitable for use in composite applications.

The invention provides a process for producing composites by the process steps of:

I. producing a reactive composition comprising
A) at least one organic diisocyanate and/or polyisocyanate and
B) at least one compound having at least one functional group reactive toward NCO groups,

where the ratio of NCO groups of A) and the functional groups of B) varies from 1:2 to 2:1;
C) a catalyst mixture comprising
   C1) at least one titanium compound and
   C2) at least one bismuth compound in a C1:C2 ratio of 100:1 to 1:100;
D) optionally additives;

where the amounts of A)-D) add up to 100% by weight,

II. directly impregnating a fibrous carrier with the composition from I.,

III. shaping to give a molding and

IV. curing the reactive composition I.

In the context of this invention, the term “composites” is used synonymously with the terms “composite components”, “composite material”, “composite molding”, “fibre-reinforced plastic”.

The diisocyanates and polyisocyanates used in accordance with the invention may consist of any desired aromatic, aliphatic, cycloaliphatic and/or (cyclo)aliphatic diisocyanates and/or polyisocyanates.

Aromatic diisocyanates or polyisocyanates used are in principle any known compounds. Particularly suitable compounds are phenylene 1,3- and 1,4-diisocyanate, naphthylene 1,5-diisocyanate, toluidine diisocyanate, tolylene 2,6-diisocyanate, tolylene 2,4-diisocyanate (2,4-TDI), diphenylmethane 2,4′-diisocyanate (2,4′-MDI), diphenylmethane 4,4′-diisocyanate, mixtures of monomeric diphenylmethane diisocyanates (MDI) and oligomeric diphenylmethane diisocyanates (polymer MDI), xylylene diisocyanate, tetramethylxylylene diisocyanate and triisocyanatotoluene.

Suitable aliphatic diisocyanates or polyisocyanates advantageously have 3 to 16 carbon atoms, preferably 4 to 12 carbon atoms, in the linear or branched alkylene radical.

Suitable cycloaliphatic or (cyclo)aliphatic diisocyanates advantageously have 4 to 18 carbon atoms, preferably 6 to 15 carbon atoms, in the cycloalkylene radical. (Cyclo)aliphatic diisocyanates are well understood in the art as referring to both cyclically and aliphatically attached NCO groups, as is the case with isophorone diisocyanate for example.

By contrast, cycloaliphatic diisocyanates are diisocyanates where only NCO groups are directly attached to the cycloaliphatic ring, e.g. H₁₂MDI.

Examples are cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, nonane triisocyanate, such as 4- isocyanatomethyl-1,8-octane diisocyanate (TIN), decane di- and triisocyanate, undecane di- and triisocyanate, dodecane di- and triisocyanates.

Preference is given to isophorone diisocyanate (IPDI), hexamethylene diisocyanate (HDI), 4,4′-diisocyanatodicyclohexylmethane, 2,4′-diisocyanatodicyclohexylmethane, 2,2′-diisocyanatodicyclohexylmethane, alone or in mixtures of the isomers (H₁₂MDI), 2-methylpentane diisocyanate (MPDI), 2,2,4-trimethylhexamethylene diisocyanate, 2,4,4-trimethylhexamethylene diisocyanate and mixtures thereof (TMDI), norbornane diisocyanate (NBDI), alone or in mixtures. Very particular preference is given to using IPDI, HDI, TMDI and H₁₂MDI, alone or in mixtures.

Likewise suitable are 4-methylcyclohexane 1,3-diisocyanate, 2-butyl-2-ethylpentamethylene diisocyanate, 3(4)-isocyanatomethyl-1 methylcyclohexyl isocyanate, 2-isocyanatopropylcyclohexyl isocyanate, 2,4′-methylenebis(cyclohexyl)diisocyanate, 1,4-diisocyanato-4 methylpentane.

It is also possible to use the isocyanurates, if they are preparable.

It will be appreciated that it is also possible to use mixtures of the diisocyanates and polyisocyanates.

In addition, preference is given to using oligo- or polyisocyanates which can be prepared from the stated diisocyanates or polyisocyanates or mixtures thereof by linking by means of urethane, allophanate, urea, biuret, uretdione, amide, isocyanurate, carbodiimide, uretonimine, oxadiazinetrione or iminooxadiazinedione structures. Isocyanurates are particularly suitable, especially of IPDI and/or HDI.

Suitable compounds B) are in principle all of those which have at least one functional group, preferably at least two functional groups, reactive toward NCO groups. Suitable functional groups are: OH, NH₂, NH, SH, CH-acidic groups. Preferably, the compounds B) contain 2 to 4 functional groups.

Particular preference is given to alcohol groups and amino groups.

Di- or polyamines B) are known in the literature. These may be monomeric, oligomeric and/or polymeric compounds. Monomeric and oligomeric compounds are preferably selected from the group of diamines, triamines, tetramines. For component B), preference is given to primary and/or secondary di- or polyamines, particular preference to primary di- or polyamines. The amino group of the di- or polyamines B) may be attached to a primary, secondary or tertiary carbon atom, preferably to a primary or secondary carbon atom.

Suitable diamines and polyamines are in principle: ethylene-1,2-diamine, propylene-1,2-diamine, propylene-1,3-diamine, butylene-1,2-diamine, butylene-1,3-diamine, butylene-1,4-diamine, 2-(ethylamino)ethylamine, 3-(methylamino)propylamine, 3-(cyclohexylamino)propylamine, 4,4′-diaminodicyclohexylmethane, isophoronediamine, 4,7-dioxadecane-1,10-diamine, N-(2-aminoethyl)ethane-1,2-diamine, N-(3-aminopropyl)propane-1,3-diamine, N,N″-1,2-ethanediylbis(propane-1,3-diamine), adipic dihydrazide, diethylenetriamine, triethylenetetramine, tetraethylenepentamine, pentaethylenehexamine, dipropylenetriamine, hydrazine, phenylene-1,3- and -1,4-diamine, diphenylmethane-4,4′-diamine, diaminodicyclohexylmethane, hexamethylenediamine, triacetonediamine, amino-functional polyethylene oxides, polypropylene oxides, adducts formed from salts of 2-acrylamido-2-methylpropane-1-sulphonic acid, and hexamethylenediamines which may also bear one or more C₁-C₄-alkyl radicals. In addition, it is also possible to use di-secondary or primary/secondary diamines as obtained, for example, in a known manner from the corresponding di-primary diamines by reaction with a carbonyl compound, for example a ketone or aldehyde, and subsequent hydrogenation, or by addition of di-primary diamines onto acrylic esters or onto maleic acid derivatives.

Components B) used may especially be the following amines:

aliphatic amines such as the polyalkylenepolyamines, diethylenetriamine, triethylenetetramine, trimethylhexamethylenediamine, 2-methylpentanediamine,

oxyalkylenepolyamines such as polyoxypropylenediamine and polyoxypropylenetriamine (e.g., Jeffamine® D-230, Jeffamine® D-400, Jeffamine® T-403, Jeffamine® T-5000), 1,13-diamino-4,7,10-trioxatridecane; 2,2,4-trimethylhexamethylenediamine or 2,4,4-trimethylhexamethylenediamine, alone or in mixtures of the isomers, cycloaliphatic amines such as isophoronediamine(3,5,5-trimethyl-3-aminomethylcyclohexylamine), 4,4′-diaminodicyclohexylmethane, 2,4′-diaminodicyclohexylmethane or 2,2′-diaminodicyclohexylmethane, alone or in mixtures of the isomers (PACM), 3,3′-dimethyl-4,4′-diaminodicyclohexylmethane, N-cyclohexyl-1,3-propanediamine, 1,2-diaminocyclohexane, piperazine, N-aminoethylpiperazine, TCD diamine(3(4), 8(9)-bis(aminomethyl)tricyclo[5.2.1.0^{2,6}]decane), araliphatic amines such as xylylenediamines, aromatic amines such as phenylenediamines and 4,4′-diaminodiphenylmethane; adduct hardeners which are the reaction products of epoxy compounds, especially glycidyl ethers of bisphenol A and F, with excess amine;

polyamidoamine hardeners which are obtained by condensation of mono- and polycarboxylic acids with polyamines, especially by condensation of dimer fatty acids with polyalkylenepolyamines;

and Mannich base hardeners which are obtained by the action of mono- or polyhydric phenols with aldehydes, especially formaldehyde, and polyamines.

Also useful are Mannich bases, for example based on phenol and/or resorcinol, formaldehyde and m-xylylenediamine, and also N-aminoethylpiperazine and blends of N-aminoethylpiperazine with nonylphenol and/or benzyl alcohol. Additionally suitable are also phenalkamines, which are frequently obtained in a Mannich reaction from cardanols, aldehydes and amines.

Preference is given to using compounds B) selected from isophoronediamine(3,5,5-trimethyl-3-aminomethylcyclohexylamine, IPD), 4,4′-diaminodicyclohexylmethane, 2,4′-diaminodicyclohexylmethane and 2,2′-diaminodicyclohexylmethane, alone or in mixtures of the isomers (also referred to as PACM), and a mixture of the isomers of 2,2,4-trimethylhexamethylenediamine and 2,4,4-trimethylhexamethylenediamine (TMD).

It is also possible to use mixtures of the aforementioned compounds B) as amine hardeners.

Mixtures of the stated diamines and polyamines are also usable.

Examples of amino alcohols include monoethanolamine, 3-amino-1-propanol, isopropanolamine, aminoethoxyethanol, N-(2-aminoethyl)ethanolamine, N-ethylethanolamine, N-butylethanolamine, diethanolamine, 3-(hydroxyethylamino)-1-propanol and diisopropanolamine, alone or as mixtures.

Suitable CH-acidic compounds are, for example, derivatives of malonic esters, acetylacetone and/or ethyl acetoacetate.

Suitable compounds B) are particularly diols and polyols having at least two OH groups.

Diols and polyols used are, for example, ethylene glycol, propane-1,2-diol, propane-1,3-diol, diethylene glycol, dipropylene glycol, triethylene glycol, tetraethylene glycol, butane-1,2-diol, butane-1,4-diol, butylethylpropane-1,3-diol, methylpropane-1,3-diol, pentane-1,5-diol, bis(1,4-hydroxymethyl)cyclohexane(cyclohexanedimethanol), glycerol, hexanediol, neopentyl glycol, trimethylolethane, trimethylolpropane, pentaerythritol, bisphenol A, bisphenol B, bisphenol C, bisphenol F, norbornylene glycol, 1,4-benzyldimethanol, 1,4-benzyldiethanol, 2,4-dimethyl-2-ethylhexane-1,3-diol, 1,4-butylene glycol, 2,3-butylene glycol, di-β-hydroxyethylbutanediol, pentane-1,5-diol, hexane-1,6-diol, octane-1,8-diol, decanediol, dodecanediol, cyclohexanediol, 3(4),8(9)-bis(hydroxymethyl)tricyclo[5.2.1.0^{2,6}]decane(dicidol), 2,2-bis(4-hydroxycyclohexyl)propane, 2,2-bis[4-(β-hydroxyethoxy)phenyl]propane, 2-methylpropane-1,3-diol, 2-methylpentane-1,5-diol, 2,2,4(2,4,4)-trimethylhexane-1,6-diol, hexane-1,2,6-triol, butane-1,2,4-triol, tris(β-hydroxyethyl)isocyanurate, mannitol, sorbitol, polypropylene glycols, polybutylene glycols, xylylene glycol or neopentylglycol hydroxypivalate, hydroxy acrylates, alone or in mixtures.

Particular preference is given to butane-1,4-diol, propane-1,2-diol, cyclohexanedimethanol, hexanediol, neopentyl glycol, decanediol, dodecanediol, trimethylolpropane, ethylene glycol, triethylene glycol, pentane-1,5-diol, hexane-1,6-diol, 3-methylpentane-1,5-diol, 2,2,4(2,4,4)-trimethylhexanediol and neopentyl glycol hydroxypivalate. They are used alone or in mixtures

Suitable compounds B) are also diols and polyols containing further functional groups. These are the familiar linear or lightly branched hydroxyl-containing polyesters, polycarbonates, polycaprolactones, polyethers, polythioethers, polyesteramides, polyacrylates, polyvinyl alcohols, polyurethanes or polyacetals, alone or in mixtures. They preferably have a number-average molecular weight of 134 to 20 000 g/mol, more preferably of 134-4000 g/mol.

In the case of the hydroxyl-containing polymers, preference is given to using polyesters, polyethers, polyacrylates, polyurethanes, polyvinyl alcohols and/or polycarbonates having an OH number of 5-500 mg KOH/gram. They preferably have a number-average molecular weight of 134 to 20 000 g/mol, more preferably of 134-4000 g/mol.

Preference is given to linear or lightly branched hydroxyl-containing polyesters—polyester polyols—or mixtures of such polyesters. They are prepared, for example, by reaction of diols with substoichiometric amounts of dicarboxylic acids, corresponding dicarboxylic anhydrides, corresponding dicarboxylic esters of lower alcohols, lactones or hydroxycarboxylic acids.

Diols and polyols suitable for preparation of the preferred polyester polyols are, as well as the abovementioned diols and polyols, also 2-methylpropanediol, 2,2-dimethylpropanediol, diethylene glycol, dodecane-1,12-diol, cyclohexane-1,4-dimethanol and cyclohexane-1,2- and -1,4-diol.

Preference is given to using butane-1,4-diol, propane-1,2-diol, cyclohexanedimethanol, hexanediol, neopentyl glycol, decanediol, dodecanediol, trimethylolpropane, ethylene glycol, triethylene glycol, pentane-1,5-diol, hexane-1,6-diol, 3-methylpentane-1,5-diol, 2,2,4(2,4,4)-trimethylhexanediol and neopentyl glycol hydroxypivalate for preparation of the polyester polyols.

Dicarboxylic acids or derivatives suitable for preparing the polyester polyols may be aliphatic, cycloaliphatic, aromatic and/or heteroaromatic in nature and may optionally be substituted, for example by halogen atoms, and/or be unsaturated.

The preferred dicarboxylic acids or derivatives include succinic acid, adipic acid, suberic acid, azelaic acid, sebacic acid, 2,2,4(2,4,4)-trimethyladipic acid, phthalic acid, phthalic anhydride, isophthalic acid, terephthalic acid, dimethyl terephthalate, tetrahydrophthalic acid, maleic acid, maleic anhydride and dimeric fatty acids.

Suitable polyester polyols further include polyester polyols obtainable in a known manner, via ring opening, from lactones, such as ε-caprolactone, and simple diols as starter molecules. It is also possible to use mono- and polyesters or lactones, e.g. ε-caprolactone or hydroxycarboxylic acids, e.g. hydroxypivalic acid, ε-hydroxydecanoic acid, ε-hydroxycaproic acid, thioglycolic acid, as starting materials for the preparation of the polymers G). Polyesters of the abovementioned (p. 6) polycarboxylic acids or derivatives thereof and polyphenols, hydroquinone, bisphenol A, 4,4′-dihydroxybiphenyl or bis(4-hydroxyphenyl)sulphone; polyesters of carbonic acid obtainable from hydroquinone, diphenylolpropane, p-xylylene glycol, ethylene glycol, butanediol or hexane-1,6-diol and other polyols by customary condensation reactions, for example with phosgene or diethyl or diphenyl carbonate, or from cyclic carbonates such as glycol carbonate or vinylidene carbonate, by polymerization in a known manner; polyesters of silicic acid, polyesters of phosphoric acid, for example of methane-, ethane-, β-chloroethane-, benzene- or styrenephosphonic acid or derivatives thereof, for example phosphoryl chlorides or phosphoric esters and polyalcohols or polyphenols of the abovementioned type; polyesters of boric acid; polysiloxanes, for example the products obtainable by hydrolysis of the dialkyldichlorosilanes with water and subsequent treatment with polyalcohols, and those obtainable by addition of polysiloxane dihydrides onto olefins, such as allyl alcohol or acrylic acid, are suitable as starting materials for the preparation of the compounds B).

The polyesters may be obtained in a manner known per se by condensation in an inert gas atmosphere at temperatures of 100 to 260° C., preferably 130 to 220° C., in the melt or in azeotropic mode, after described, for example, in Methoden der Organischen Chemie [Methods of Organic Chemistry] (Houben-Weyl); volume 14/2, pages 1 to 5, 21 to 23, 40 to 44, Georg Thieme Verlag, Stuttgart, 1963, or in C. R. Martens, Alkyd Resins, pages 51 to 59, Reinhold Plastics Appl. Series, Reinhold Publishing Comp., New York, 1961.

Additionally usable with preference are linear or branched polyether polyols. Examples of these are Lupranol 1000, 1100, 2032, 3402, 3300, 3422, 3504/1, 3505/1, Polyol 4800, 4640, 4525, 4360, polytetramethylene ether glycols, for example Terathane 250, 650, 1000 and 2000, Voranol CP 300, CP 450, CP 755, Caradol ET 380-02, ET 570-02, Sovermol 750, 760, 805, 810 and 815.

Likewise usable with preference are (meth)acrylates and poly(meth)acrylates containing OH groups. They are prepared by copolymerization of

(meth)acrylates, where individual components bear OH groups but others do not. This produces a randomly distributed polymer containing OH groups, which contains one or many OH groups. Polymers of this kind are described in High solids hydroxy acrylics with tightly controlled molecular weight. van Leeuwen, Ben. SC Johnson Polymer, Neth. PPCJ, Polymers Paint Colour Journal (1997), 187(4392), 11-13;

Special techniques for synthesis of high solid resins and applications in surface coatings. Chakrabarti, Suhas; Ray, Somnath. Berger Paints India Ltd., Howrah, India. Paintindia (2003), 53(1), 33-34, 36, 38-40;

VOC protocols and high solid acrylic coatings. Chattopadhyay, Dipak K.; Narayan, Ramanuj; Raju, K. V. S. N. Organic Coatings and Polymers Division, Indian Institute of Chemical Technology, Hyderabad, India. Paintindia (2001), 51(10), 31-42.

The diols and dicarboxylic acids or derivatives thereof used for preparation of the polyester polyols may be used in any desired mixtures.

It is also possible to use mixtures selected from polyether polyols, polyester polyols and/or diols.

Components B) used may also be epoxy-containing compounds.

Suitable compounds B) are the reaction products of polycarboxylic acid and glycidyl compounds, as described, for example, in DE-A 24 10 513.

Examples of suitable compounds which can be used are esters of 2,3-epoxy-1-propanol with monobasic acids having 4 to 18 carbon atoms, such as glycidyl palmitate, glycidyl laurate and glycidyl stearate, alkylene oxides having 4 to 18 carbon atoms, such as butylene oxide, and glycidyl ethers such as octyl glycidyl ether.

Any epoxy resins are useful in principle as epoxy resin component B). Epoxy resins include, for example, polyepoxides based on bisphenol A diglycidyl ether, bisphenol F diglycidyl ether or cycloaliphatic types.

Preference is given in accordance with the invention to using epoxy resins selected from the group comprising epoxy resins based on bisphenol A diglycidyl ether, epoxy resins based on bisphenol F diglycidyl ether and cycloaliphatic types, for example 3,4-epoxycyclohexylepoxyethane or 3,4-epoxycyclohexylmethyl 3,4-epoxycyclohexanecarboxylate, particular preference being given to bisphenol A-based epoxy resins and to bisphenol F-based epoxy resins.

According to the invention, it is also possible to use mixtures of epoxy resins as component B).

Compounds B) are also those which bear, as well as an epoxy group, at least one further functional group, for example carboxyl, hydroxyl, mercapto or amino groups, which is capable of reaction with an isocyanate group. Particular preference is given to 2,3-epoxy-1-propanol and epoxidized soya oil.

It is possible to use any desired combinations of the abovementioned compounds B).

Suitable components C1 are titanium complexes. Suitable ligands for titanium complexes are:

alkyl groups, especially methyl, ethyl, propyl, butyl, pentyl, hexyl, heptyl, octyl, nonyl, decyl, stearyl, isostearyl;

alkoxides, especially methoxide, ethoxide, propoxide, isopropoxide, butoxide, tert-butoxide, pentoxide, neopentoxide, hexoxide, octoxide, 1-naphthoxide, phenoxide, propylphenoxide, 4-dodecylphenoxide, quinolinate, diethyleneglycolate, pentanediolate, hexanediolate, 2-ethylhexane-1,3-diolate,

carboxylates, especially formate, acetate, propionoate, butanoate, isobutanoate, pentanoate, neopentanoate, hexanoate, cyclohexanoate, heptanoate, octanoate, 2-ethylhexanoate, nonanoate, decanoate, neodecanoate, undecanoate, dodecanoate, stearate, lactate, oleate, citrate, benzoate, salicylate and phenylacetate, hydroxyhexanoate;

1,3-diketonates, especially acetylacetonate(pentane-2,4-dionate), 2,2,6,6-tetramethylheptane-3,5-dionate, 1,3-diphenylpropane-1,3-dionate(dibenzoylmethanate), 1-phenylbutane-1,3-dionate and 2-acetylcyclohexanonate; oxinate;

1,3-ketoesterates, especially methylacetoacetate, ethylacetoacetate, ethyl-2-methylacetoacetate, ethyl-2-ethylacetoacetate, ethyl-2-hexylacetoacetate, ethyl-2-phenylacetoacetate, propylacetoacetate, isopropylacetoacetate, butylacetoacetate, tert-butylacetoacetate, ethyl-3-oxovalerate, ethyl-3-oxohexanoate and 2-oxocyclohexanecarboxylic acid ethyl esterate;

amino alcohols, for example diethanolamine or triethanolamine.

Preference is given to using titanium compounds having the following ligands: propyl, butyl, pentyl, propoxide, isopropoxide, butoxide, tert-butoxide, pentoxide, diethylene glycolate, pentanediolate, hexanediolate, 2-ethylhexane-1,3-diolate, acetylacetonate, ethylacetoacetate and triethanolamine.

It is also possible to use mixtures of titanium compounds.

Very particular preference is given to using titanium compounds having the following ligands: butyl, pentyl, butoxide, pentoxide, diethylene glycolate, hexanediolate, 2-ethyl-1,3-ethylacetoacetate and triethanolamine.

It is also possible to use mixtures of the titanium complexes listed.

Suitable components C2 are also bismuth complexes. Suitable ligands for bismuth complexes are:

alkoxides, especially methoxide, ethoxide, propoxide, isopropoxide, butoxide, tert-butoxide, pentoxide, neopentoxide, hexoxide and octoxide; carboxylates, especially formate, acetate, propionate, butanoate, isobutanoate, pentanoate, neopentanoate, hexanoate, cyclohexanoate, heptanoate, octanoate, 2-ethylhexanoate, nonanoate, decanoate, neodecanoate, undecanoate, dodecanoate, lactate, oleate, citrate, benzoate, salicylate and phenylacetate;

1,3-diketonates, especially acetylacetonate(2,4-pentanedionate), 2,2,6,6-tetramethyl-3,5-heptanedionate, 1,3-diphenyl-1,3-propanedionate(dibenzoylmethanate), 1-phenyl-1,3-butanedionate and 2-acetylcyclohexanonate;

oxinate;

1,3-ketoesterates, especially methylacetoacetate, ethylacetoacetate, ethyl-2-methylacetoacetate, ethyl-2-ethylacetoacetate, ethyl-2-hexylacetoacetate, ethyl-2-phenylacetoacetate, propylacetoacetate, isopropylacetoacetate, butylacetoacetate, tert-butylacetoacetate, ethyl-3-oxovalerate, ethyl-3-oxohexanoate and 2-oxocyclohexanecarboxylic acid ethyl esterate;

1,3-ketoamidates, especially N,N-diethyl-3-oxobutanamidate, N,N-dibutyl-3-oxobutanamidate, N,N-bis(2-ethylhexyl)-3-oxobutanamidate, N,N-bis(2-methoxyethyl)-3-oxobutanamidate, N,N-dibutyl-3-oxoheptanamidate, N,N-bis(2-methoxyethyl)-3-oxoheptanamidate, N,N-bis(2-ethylhexyl)-2-oxocyclopentancarboxamidate, N,N-dibutyl-3-oxo-3-phenylpropanamidate, N,N-bis(2-methoxyethyl)-3-oxo-3-phenylpropanamidate;

and N-polyoxyalkylene-1,3-ketoimidates such as, in particular, acetoamidates of polyoxyalkyleneamines having one, two or three amino groups.

Preference is given to bismuth complexes having carboxylate ligands, especially octanoate, 2-ethylhexanoate, neodecanoate or neopentanoate, or else bismuth oxides.

Examples of such bismuth complexes are K-Kat 348 (bismuth carboxylate), XC B 221 (bismuth neodecanoate), XK 640 (bismuth carboxylate) and XK 601 (bismuth carboxylate) from King Industries, bismuth neodecanoate (Coscat 83 from Vertellus Performance Materials), Borchi Kat 320 (bismuth 2-ethylhexanoate) and 315 (bismuth neodecanoate) from OMG Borchers GmbH and TIB KAT 716 (bismuth carboxylate), 716LA (bismuth carboxylate), 718 (mixture of bismuth carboxylate and zinc neodecanoate), 720 (bismuth carboxylate) and 789 (bismuth oxid) from TIB Chemicals.

It is also possible to use mixtures of the bismuth complexes listed.

Preferably, the C1:C2 ratio is from 10:1 to 1:10. More preferably, the C1:C2 ratio is from 10:1 to 1:1.

Carrier

The carrier material used with preference in the semi-finished composite product in the process according to the invention is characterized in that the fibrous carriers consist for the most part of glass, carbon, polymers such as polyamide (aramid) or polyesters, natural fibres, or mineral fibre materials such as basalt fibres or ceramic fibres, individually or of mixtures, or of multiple plies of various fibre types.

The fibrous carriers take the form of sheetlike textile structures made from nonwoven fabric, of knitted fabric including loop-formed and loop-drawn knits, of non-knitted structures such as woven fabrics, laid scrims or braids, or of long-fibre or short-fibre materials, individually or of multiple plies of various fibre types.

The detailed execution is as follows: The fibrous carrier in the present invention consists of fibrous material (also often called reinforcing fibres). Any material that the fibres consist of is generally suitable, but preference is given to using fibrous material made of glass, carbon, plastics such as polyamide (aramid) or polyester, natural fibres, or mineral fibre materials such as basalt fibres or ceramic fibres (oxidic fibres based on aluminium oxides and/or silicon oxides). It is also possible to use mixtures of fibre types, for example woven fabric combinations of aramid and glass fibres, or carbon and glass fibres. Hybrid composite parts comprising prepregs composed of different fibrous carriers are likewise suitable.

Mainly because of their relatively low cost, glass fibres are the most commonly used fibre types. In principle here, all types of glass-based reinforcing fibres are suitable (E-glass, S-glass, R-glass, M-glass, C-glass, ECR-glass, D-glass, AR-glass, or hollow glass fibres).

Carbon fibres are generally used in high-performance composites, where another important factor is the lower density compared to glass fibres with simultaneously high strength. Carbon fibres are industrially produced fibres composed of carbonaceous starting materials which are converted by pyrolysis to carbon in a graphite-like arrangement. A distinction is made between isotropic and anisotropic types: isotropic fibres have only low strengths and lower industrial significance; anisotropic fibres exhibit high strengths and rigidities with simultaneously low elongation at break. Natural fibres refer here to all textile fibres and fibrous materials which are obtained from plant and animal material (for example wood fibres, cellulose fibres, cotton fibres, hemp fibres, jute fibres, flax fibres, sisal fibres and bamboo fibres). Similarly to carbon fibres, aramid fibres exhibit a negative coefficient of thermal expansion, i.e. become shorter on heating. Their specific strength and their modulus of elasticity are markedly lower than those of carbon fibres. In combination with the positive coefficient of expansion of the matrix resin, it is possible to produce components of high dimensional stability. Compared to carbon fibre-reinforced plastics, the compressive strength of aramid fibre composites is much lower. Known brand names for aramid fibres are Nomex® and Kevlar® from DuPont, or Teijinconex®, Twaron® and Technora® from Teijin. Particularly suitable and preferred carriers are those made of glass fibres, carbon fibres, aramid fibres or ceramic fibres. The fibrous material is a sheetlike textile structure. Suitable materials are sheetlike textile structures made from nonwoven fabric, and likewise knitted fabric including loop-formed and loop-drawn knits, but also non-knitted fabrics such as woven fabrics, laid scrims or braids. In addition, a distinction is made between long-fibre and short-fibre materials as carriers. Likewise suitable in accordance with the invention are rovings and yarns. In the context of the invention, all the materials mentioned are suitable as fibrous carriers. An overview of reinforcing fibres is contained in “Composites Technologies”, Paolo Ermanni (Version 4), script for lecture at ETH Zürich, August 2007, Chapter 7.

The compositions I. used in accordance with the invention may contain further additives which are preferably added wholly or partly to the polyol component. These are understood to mean substances which are generally added in order to alter the properties of the polyurethane in the desired direction, for example to match viscosity, wetting characteristics, stability, reaction rate, blister formation, stirrability or adhesion, and also use properties, to the end use. Examples of additives are levelling agents, separating agents, reaction retardants, thixotropic agents, ageing stabilizers, dyes, desiccants, resins and/or wetting agents.

Further additives may be stabilizers. Stabilizers in the context of this invention are understood to mean antioxidants, UV stabilizers or hydrolysis stabilizers. Examples thereof are the commercial sterically hindered phenols and/or thioethers and/or substituted benzotriazoles and/or amines of the “HALS” type (hindered amine light stabilizers).

Further additives may be plasticizers, colour pastes, molecular sieves, pigments or fillers. It is also possible to use desiccants which capture moisture during storage.

The additives are chosen such that they do not enter into any reactions or side reactions with isocyanates, at least not within the duration of the crosslinking reaction.

Reaction retardants in the context of this invention are understood to mean substances which slow the reaction between OH and NCO groups. Acidic compounds are suitable for this purpose, for example organic or inorganic carboxylic acids, acid chlorides, acidic inorganic salts or other acidic organic compounds. These should be present in amounts of 0.05% to 3.0% by weight.

Organic acids for use as reaction retardants in accordance with the invention are those which have, for example, a pKa range between 2.8 and 4.5, such as phthalic acid, isophthalic acid, terephthalic acid, ascorbic acid, benzoic acid, o-hydroxybenzoic acid, p-hydroxybenzoic acid, 2,3-dihydroxybenzoic acid, 2,4-dihydroxybenzoic acid, 3,4-dihydroxybenzoic acid, salicylic acid, adipic acid, succinic acid, malic acid, acetylsalicylic acid, alanine, β-alanine, 4-aminobutyric acid, glycine, lactic acid, sarcosine, serine. It is also possible to use formic acid, acetic acid, monochloro- or dichloroacetic acid, 2,4- or 2,6-dichlorophenylacetic acid; phosphoric acid, hydrogenphosphates; polymeric cation exchangers having carboxyl groups or having orthophosphate groups; lithium chloride, 4-toluenesulphonyl isocyanate or acid chlorides of the abovementioned carboxylic acids.

It is possible to use the aforementioned compounds as additives either individually or as mixtures.

Said additives are described, for example, in WO 99/55772, p. 15-25, and in “Plastics Additives”, R. Gächter and H. Müller, Hanser Publishers 1983.

For preparation of the two-pack polyurethane composition I. used in accordance with the invention, first of all, the polyol component is prepared. For this purpose, the liquid polyols can be mixed, then any solid components should be dissolved in the mixture. This can also be promoted by heating. Subsequently, the auxiliaries are mixed in and dispersed. In the course of this, the moisture content should be kept low; for example, water levels can be reduced through the use of the desiccants such as zeolite or by drying under reduced pressure. Inert auxiliaries can also partly be added to the isocyanate component. The two components are stored separately until use. For use, these two components are mixed with one another in a manner known per se. To this end, it is possible to use standard mixing units which are common knowledge to those skilled in the art. After the components have been mixed, the mixture is transferred into a mould via a hose.

In order to enable a use according to the invention, the two-pack PU composition I. used in accordance with the invention has a viscosity in mixed form of 30 to 3000 mPas, measured at a temperature between 20 and 80° C. More particularly, viscosity should be from 100 to 1500 mPas, preferably below 1000 mPas, measured at 40 to 80° C. In this case, two-pack PU composition may be applied at this temperature. The viscosity should be determined immediately after mixing; as a result of the onset of the crosslinking reaction, it increases gradually.

The composition I. has a glass transition temperature (Tg) of 50 to 160° C. (measured by DSC, DIN 11357), especially 70 to 120° C.

The production of the composites, i.e. the production of composite components, can be conducted as follows: The compositions I. are applied by introduction into a mould. The latter is to contain the abovementioned fibre materials, for example in a directed form. According to the invention, in a batchwise or continuous manner, components B, C1, C2 and optionally D are mixed. Subsequently, the mixture of components B, C1, C2 and optionally D is mixed with component A. Immediately thereafter, the liquid mixture is introduced into a closed mould. The fibre materials are already present in the mould and arranged in the desired position. The compositions according to the invention can be introduced into the mould by means of vacuum or pressure. In doing this, it should be ensured that the flow rate is selected such that air or gases between the fibre materials can escape. In another mode of operation, the mould containing the fibre material is covered with a film and sealed vacuum-tight at the edge. The mould has orifices through which a reduced pressure can be applied to the mould. The reduced pressure results in homogeneous suction of the mixture according to the invention into the mould. In this mode of operation, it is advantageous that it is possible through the reduced pressure to avoid possible inclusions of bubbles. Infusion methods of this kind are known in principle to those skilled in the art.

The invention also provides for the use of the composites, especially with fibrous carriers composed of glass fibres, carbon fibres or aramid fibres.

The invention especially also provides for the use of the composites produced in accordance with the invention in boat- and shipbuilding, in aerospace technology, in automobile construction, for two-wheeled vehicles, preferably motorcycles and pedal cycles, in the automotive, construction, medical technology and sports sectors, the electrical and electronics industry, and in energy generation installations, for example for rotor blades in wind turbines.

The invention also provides the composite components produced in accordance with the invention, formed from at least one fibrous carrier and at least one crosslinked reactive composition.

The invention also provides composites obtained by the process steps of:

I. producing a reactive composition comprising
A) at least one organic diisocyanate and/or polyisocyanate and
B) at least one compound having at least one functional group reactive toward NCO groups,

where the ratio of NCO groups of A) and the functional groups of B) varies from 1:2 to 2:1;
C) a catalyst mixture comprising
   C1) at least one titanium compound and
   C2) at least one bismuth compound in a C1:C2 ratio of 100:1 to 1:100;
D) optionally additives;

where the amounts of A)-D) add up to 100% by weight,

II. directly impregnating a fibrous carrier with the composition from I.,

III. shaping to give a molding and

IV. curing the reactive composition I.

Having generally described this invention, a further understanding can be obtained by reference to certain specific examples which are provided herein for purposes of illustration only, and are not intended to be limiting unless otherwise specified.

### EXAMPLES

The composite materials were produced from polyurethane matrix and fibre by mixing components B, C1 and C2 and optionally D at 30° C., heating the mixture to 80° C. and mixing it with component A, likewise preheated at 80° C., with the aid of a high-speed stirrer. Subsequently, the mixture was placed into a pressure vessel and heat-treated at 60° C. The pressure vessel was connected by hoses to a closed metal mould (internal dimensions 320×320×2 mm). The metal mould was preheated to 90° C. and filled with the fibre material. The cavity of the mould was 2 mm. The matrix system was infused at 4 bar from the pressure vessel into the mould. After 3 min, the infusion was ended. The material was cured in the mould at 90° C. for 40 min. Then the molding was demoulded.

The apparent interlaminar shear strength (ILSS, described in DIN EN ISO 14130) of the fibre-reinforced sheet was determined as a measure of the fibre-matrix adhesion. The apparent interlaminar shear strength is low when it is less than 50 MPa. It is moderately high when it is between 50 and 58 MPa. Particularly good adhesion between fibre and matrix has been attained when the apparent interlaminar shear strength is 58 MPa or more.

The polyurethane matrix was obtained by the reaction of 100 parts of the isocyanate component (Table 1) and 27 parts of the polyol component (Table 2). The chemical names corresponding to the trade names for the catalysts utilized in the examples are listed in Table 3. The individual examples including the physical and chemical properties are listed in Tables 4 and 5.

TABLE 1
Composition of the isocyanate component

| % by weight | Isocyanate component |
|---|---|
| 24 | Vestanat T1890/100 |
| 76 | Vestanat T2500/100 |

TABLE 2
Composition of the polyol component

| % by weight | Polyol component |
|---|---|
| Remainder to 100 | Lupranol 3902 |
| 30 | Propane-1,2-diol |
| Y | Catalysts and amount (see Table 4) |

TABLE 3
Details of trade names for the substances used in the examples

| Trade name | Chemical name | Supplier |
|---|---|---|
| Vestanat | Isophorone diisocyanate | Evonik Industries |
| T1890/100 | homopolymer (isocyanurate type), | AG, Coatings & |
| | CAS No. 53880-05-0 | Additives, |
| | | D-45764 Marl |
| Vestanat | Hexamethylene 1,6-diisocyanate | Evonik Industries |
| T2500/100 | homopolymer (isocyanurate type), | AG, Coatings & |
| | CAS No. 28182-81-2 | Additives, |
| | | D-45764 Marl |
| Lupranol 3902 | 1,1,1-Trimethylolpropane, | BASF Polyurethanes |
| | propoxylated, | GmbH Postfach 1140 |
| | CAS No. 25723-16-4 | D-49440 Lemfoerde |
| Propylene | Propane-1,2-diol, | Sigma-Aldrich |
| glycol | CAS No. 57-55-6 | Chemie GmbH |
| | | Riedstr. 2, |
| | | D-89555 Steinheim |
| TiB Kat 216 | Dibutyltin dilaurate, | TIB Chemicals AG, |
| | CAS No. 77-58-7 | Mühlheimer Str. |
| | | 16-22, |
| | | D-68219 Mannheim |
| Coscat 83 | Bismuth(III) neodecanoate in | Vertellus |
| | neodecanoic acid, | Performance |
| | CAS No. 34364-26-6 | Materials, 2110 |
| | | High Point Road, |
| | | Greensboro, NC |
| | | 27403 USA |
| TIB KAT 716 | Bismuth carboxylate | TIB Chemicals AG, |
| | | Mühlheimer Str. |
| | | 16-22, |
| | | D-68219 Mannheim |
| Tyzor OGT | Tetrakis(2-ethylhexane-1,3- | Dorf Ketal Speciality |
| | diolato)titanium, | Catalysts LLC, 3727 |
| | CAS No. 5575-43-9 | Greenbriar Dr., |
| | | Suite 114, Stafford |
| | | TX 77477, USA |
| Tyzor AA 95 | Bis(acetylacetonato)titanium(IV) | Dorf Ketal Speciality |
| | ethoxide isopropoxide in butanol, | Catalysts LLC, 3727 |
| | CAS No. 97281-09-9 | Greenbriar Dr., |
| | | Suite 114, Stafford |
| | | TX 77477, USA |

TABLE 4
Examples according to invention

| | Titanium catalyst | | Bismuth catalyst | | |
|---|---|---|---|---|---|
| Experiment | | Amount | | Amount | ILSS |
| No. | Name | [%] | | [%] | [MPa] |
| 1 | Tyzor OGT | 0.1 | Coscat 83 | 0.01 | 58.8 |
| 2 | Tyzor AA 95 | 0.1 | Coscat 83 | 0.01 | 62.1 |
| 3 | Tyzor OGT | 0.1 | TIB Kat 716 | 0.01 | 61.3 |

TABLE 5
Comparative examples

| Experiment | Catalyst | | ILSS |
|---|---|---|---|
| No. | Name | Amount [%] | [MPa] |
| 4 | Tyzor OGT | 0.1 | 51.7 |
| 5 | Coscat 83 | 0.1 | 48.8 |
| 6 | No catalyst | — | 47.6 |
| 7 | DBTL | 0.1 | 51.2 |

European patent application EP14195385 filed Nov. 28, 2014, is incorporated herein by reference.

Numerous modifications and variations on the present invention are possible in light of the above teachings. It is therefore to be understood that within the scope of the appended claims, the invention may be practiced otherwise than as specifically described herein.

1. A process for producing a composite, comprising:
I. producing a reactive composition comprising
A) at least one organic diisocyanate and/or polyisocyanate;
B) at least one compound having at least one functional group reactive toward NCO groups,
wherein the ratio of NCO groups of A) and the functional groups of B) varies from 1:2 to 2:1;
C) a catalyst mixture comprising
C1) at least one titanium compound and
C2) at least one bismuth compound in a C1:C2 ratio of 100:1 to 1:100; and
D) optionally, an additive;
wherein the amounts of A)-D) add up to 100% by weight,
II. directly impregnating a fibrous carrier with the composition from I., to obtain an impregnated fibrous carrier,
III. shaping the impregnated fibrous carrier to give a molding, and
IV. curing the reactive composition I.

2. The process according to claim 1, wherein diisocyanates and/or polyisocyanates A) are selected from the group consisting of aromatic, aliphatic, cycloaliphatic, (cyclo)aliphatic diisocyanates, polyisocyanates, and mixtures thereof.

3. The process according to claim 1, wherein the diisocyanate is selected from the group consisting of isophorone diisocyanate, hexamethylene diisocyanate, 4,4′-diisocyanatodicyclohexylmethane, 2,4′-diisocyanatodicyclohexylmethane, 2,2′-diisocyanatodicyclohexylmethane, 2-methylpentane diisocyanate, 2,2,4-trimethylhexamethylene diisocyanate, 2,4,4-trimethylhexamethylene diisocyanate, norbornane diisocyanate, and mixtures thereof.

4. The process according to claim 1, wherein compounds B) are compounds having 2 to 4 functional groups.

5. The process according to claim 1, wherein compounds B) are compounds having functional groups selected from the group consisting of OH, NH₂, NH, SH, CH-acidic groups and combinations thereof.

6. The process according to claim 1, wherein compounds B) are compounds having at least two alcohol groups and/or amino groups.

7. The process according to claim 1, wherein compounds B) are selected from the group consisting of
ethylene-1,2-diamine, propylene-1,2-diamine, propylene-1,3-diamine, butylene-1,2-diamine, butylene-1,3-diamine, butylene-1,4-diamine, 2-(ethylamino)ethylamine, 3-(methylamino)-propylamine, 3-(cyclohexylamino)propylamine, 4,4′-diaminodicyclohexylmethane, isophoronediamine, 4,7-dioxadecane-1,10-diamine, N-(2-aminoethyl)ethane-1,2-diamine, N-(3-aminopropyl)propane-1,3-diamine, N,N″-1,2-ethanediylbis(propane-1,3-diamine), adipic dihydrazide, diethylenetriamine, triethylenetetramine, tetraethylenepentamine, pentaethylenehexamine, dipropylenetriamine, hydrazine, phenylene-1,3- and -1,4-diamine, diphenylmethane-4,4′-diamine, diaminodicyclohexylmethane, hexamethylenediamine, triacetonediamine, amino-functional polyethylene oxides, polypropylene oxides,
adducts formed from salts of 2-acrylamido-2-methylpropane-1-sulphonic acid, hexamethylenediamines which may also bear one or more C1-C4-alkyl radicals, di-secondary or primary/secondary diamines as obtained from the corresponding di-primary diamines by reaction with a carbonyl compound and subsequent hydrogenation or by addition of di-primary diamines onto acrylic esters or onto maleic acid derivatives; and mixtures thereof.

8. The process according to claim 1, wherein components B) are the following amines, alone or in mixtures:
aliphatic amines selected from the group consisting of polyalkylenepolyamines, diethylenetriamine, triethylenetetramine, trimethylhexamethylenediamine, 2-methylpentanediamine,
polyoxypropylenediamine, polyoxypropylenetriamine, 1,13-diamino-4,7,10-trioxatridecane, 2,2,4-trimethylhexamethylenediamine, 2,4,4-trimethylhexamethylenediamine, and mixtures thereof;
cycloaliphatic amines selected from the group consisting of isophoronediamine (3,5,5-trimethyl-3-aminomethylcyclohexylamine), 4,4′-diaminodicyclohexylmethane, 2,4′-diaminodicyclohexylmethane, 2,2′-diaminodicyclohexylmethane, 3,3′-dimethyl-4,4′-diaminodicyclohexylmethane, N-cyclohexyl-1,3-propanediamine, 1,2-diaminocyclohexane, piperazine, N-aminoethylpiperazine, 3(4),8(9)-bis(aminomethyl)tricyclo[5.2.1.02,6]decane, and mixtures thereof;
araliphatic amines selected from the group consisting of xylylenediamines, and mixtures thereof;
aromatic amines selected from the group consisting of phenylenediamines, 4,4′-diaminodiphenylmethane, and mixtures thereof;
adduct hardeners which are the reaction products of epoxy compounds with excess amine;
polyamidoamine hardeners which are obtained by condensation of mono- and polycarboxylic acids with polyamines;
Mannich base hardeners which are obtained by the action of mono- or polyhydric phenols with aldehydes;
Mannich bases based on phenol and/or resorcinol, formaldehyde and m-xylylenediamine and/or N-aminoethylpiperazine;
blends of N-aminoethylpiperazine with nonylphenol and/or benzyl alcohol;
phenalkamines.

9. The process according to claim 1, wherein amines B) used, alone or in mixtures, are isophoronediamine, 4,4′-diaminodicyclohexylmethane, 2,4′-diaminodicyclohexylmethane,
2,2′-diaminodicyclohexylmethane, alone or in mixtures of the isomers, or a mixture of the isomers of 2,2,4-trimethylhexamethylenediamine and 2,4,4-trimethylhexamethylenediamine.

10. The process according to claim 1, wherein amino alcohols B) are monoethanolamine, 3-amino-1-propanol, isopropanolamine, aminoethoxyethanol, N-(2-aminoethyl)ethanolamine, N-ethylethanolamine, N-butylethanolamine, diethanolamine, 3-(hydroxyethylamino)-1-propanol and diisopropanolamine, alone or in mixtures.

11. The process according to claim 1, wherein components B) are ethylene glycol, propane-1,2-diol, propane-1,3-diol, diethylene glycol, dipropylene glycol, triethylene glycol, tetraethylene glycol, butane-1,2-diol, butane-1,4-diol, butylethylpropane-1,3-diol, methylpropane-1,3-diol, pentane-1,5-diol, bis(1,4-hydroxymethyl)cyclohexane(cyclohexanedimethanol), glycerol, hexanediol, neopentyl glycol, trimethylolethane, trimethylolpropane, pentaerythritol, bisphenol A, bisphenol B, bisphenol C, bisphenol F, norbornylene glycol, 1,4-benzyldimethanol, 1,4-benzyldiethanol, 2,4-dimethyl-2-ethylhexane-1,3-diol, 1,4-butylene glycol, 2,3-butylene glycol, di-β-hydroxyethylbutanediol, pentane-1,5-diol, hexane-1,6-diol, octane-1,8-diol, decanediol, dodecanediol, cyclohexanediol, 3(4),8(9)-bis(hydroxymethyl)tricyclo[5.2.1.02,6]decane(dicidol), 2,2-bis(4-hydroxycyclohexyl)propane, 2,2-bis[4-(β-hydroxyethoxy)phenyl]propane, 2-methylpropane-1,3-diol, 2-methylpentane-1,5-diol, 2,2,4(2,4,4)-trimethylhexane-1,6-diol, hexane-1,2,6-triol, butane-1,2,4-triol, tris(β-hydroxyethyl)isocyanurate, mannitol, sorbitol, polypropylene glycols, polybutylene glycols, xylylene glycol or neopentylglycol hydroxypivalate, hydroxy acrylates, alone or in mixtures.

12. The process according to claim 1, wherein components B) are hydroxyl-containing polyesters, polycarbonates, polycaprolactones, polyethers, polythioethers, polyester amides, polyacrylates, polyvinyl alcohols, polyurethanes or polyacetals, alone or in mixtures.

13. The process according to claim 1, wherein components B) are epoxy-containing compounds.

14. The process according to claim 1, wherein components C1 are titanium complexes having ligands selected from the group consisting of:
alkyl groups, alkoxides, carboxylates, 1,3-diketonates, 1,3-ketoesterates,
amino alcohols, and mixtures thereof.

15. The process according to claim 1, wherein components C1 are titanium complexes having ligands selected from the group consisting of:
alkyl groups, especially methyl, ethyl, propyl, butyl, pentyl, hexyl, heptyl, octyl, nonyl, decyl, stearyl, isostearyl;
methoxide, ethoxide, propoxide, isopropoxide, butoxide, tert-butoxide, pentoxide, neopentoxide, hexoxide, octoxide, 1-naphthoxide, phenoxide, propylphenoxide, 4-dodecylphenoxide, quinolinate, diethyleneglycolate, pentanediolate, hexanediolate, 2-ethylhexane-1,3-diolate,
formate, acetate, propionoate, butanoate, isobutanoate, pentanoate, neopentanoate, hexanoate, cyclohexanoate, heptanoate, octanoate, 2-ethylhexanoate, nonanoate, decanoate, neodecanoate, undecanoate, dodecanoate, stearate, lactate, oleate, citrate, benzoate, salicylate and phenylacetate, hydroxyhexanoate;
acetylacetonate(pentane-2,4-dionate), 2,2,6,6-tetramethylheptane-3,5-dionate, 1,3-diphenylpropane-1,3-dionate(dibenzoylmethanate), 1-phenylbutane-1,3-dionate and 2-acetylcyclohexanonate; oxinate;
methyl acetoacetate, ethyl acetoacetate, ethyl 2-methylacetoacetate, ethyl 2-ethylacetoacetate, ethyl 2-hexylacetoacetate, ethyl 2-phenylacetoacetate, propyl acetoacetate, isopropyl acetoacetate, butyl acetoacetate, tert-butyl acetoacetate, ethyl 3-oxovalerate, ethyl 3-oxohexanoate and 2-oxocyclohexanecarboxylic acid ethyl esterate;
diethanolamine or triethanolamine,
and mixtures thereof.

16. The process according to claim 1, wherein components C2 are bismuth complexes having ligands selected from the group consisting of:
alkoxides, carboxylates, 1,3-diketonates, 1,3-ketoesterates, oxinates, 1,3-ketoamidates, N-polyoxyalkylene-1,3-ketoamidates, and mixtures thereof.

17. The process according to claim 1, wherein components C2 are bismuth complexes having ligands selected from the group consisting of:
methoxide, ethoxide, propoxide, isopropoxide, butoxide, tert-butoxide, pentoxide, neopentoxide, hexoxide and octoxide; carboxylates, especially formate, acetate, propionate, butanoate, isobutanoate, pentanoate, neopentanoate, hexanoate, cyclohexanoate, heptanoate, octanoate, 2-ethylhexanoate, nonanoate, decanoate, neodecanoate, undecanoate, dodecanoate, lactate, oleate, citrate, benzoate, salicylate and phenylacetate; acetylacetonate(pentane-2,4-dionate), 2,2,6,6-tetramethylheptane-3,5-dionate, 1,3-diphenylpropane-1,3-dionate(dibenzoylmethanate), 1-phenylbutane-1,3-dionate and 2-acetylcyclohexanonate; oxinate; methylacetoacetate, ethylacetoacetate, ethyl-2-methylacetoacetate, ethyl-2-ethylacetoacetate, ethyl-2-hexylacetoacetate, ethyl-2-phenylacetoacetate, propylacetoacetate, isopropylacetoacetate, butylacetoacetate, tert-butylacetoacetate, ethyl-3-oxovalerate, ethyl-3-oxohexanoate and 2-oxocyclohexanecarboxylic acid ethyl esterate; N,N-diethyl-3-oxobutanamidate, N,N-dibutyl-3-oxobutanamidate, N,N-bis(2-ethylhexyl)-3-oxobutanamidate, N,N-bis(2-methoxyethyl)-3-oxobutanamidate, N,N-dibutyl-3-oxoheptanamidate, N,N-bis(2-methoxyethyl)-3-oxoheptanamidate, N,N-bis(2-ethylhexyl)-2-oxocyclopentancarboxamidate, N,N-dibutyl-3-oxo-3-phenylpropanamidate, N,N-bis(2-methoxyethyl)-3-oxo-3-phenylpropanamidate, acetoamidates of polyoxyalkyleneamines having one, two or three amino groups,
and mixtures thereof.

18. The process according to claim 1, wherein components C2 are bismuth complexes having ligands selected from the group consisting of: octanoate, ethylhexanoate, neodecanoate and neopentanoate.

19. The process according to claim 1, wherein the fibrous carriers comprise glass, carbon, plastics, natural fibres and/or mineral fibre materials, individually or in combinations, or multiple plies of various fibers.

20. The process according to claim 1, wherein an additional additive selected from the group consisting of levelling agents, separating agents, reaction retardants, thixotropic agents, ageing stabilizers, dyes, desiccants, resins, wetting agents, stabilizers, plasticizers, colour pastes, molecular sieves, pigments and fillers is used, alone or in mixtures.

21. A composite, obtained by the process of claim 1.
